(19) United States
(12) Patent Application Publication
(10) Pub. No.: US 2017/0197647 A1
(43) Pub. Date: Jul. 13, 2017

(54) Shelf for a Rolling Container, Rolling Container Provided Therewith and Method Therefor

(71) Applicant: Container Centralen A/S, Odense (DK)

(72) Inventor: Harm Bouma, Scheemda (NL)

(21) Appl. No.: 15/470,389

(22) Filed: Mar. 27, 2017

Related U.S. Application Data
(63) Continuation of application No. PCT/NL2015/050668, filed on Sep. 25, 2015.

(30) Foreign Application Priority Data
Sep. 26, 2014 (NL) 2013535
Oct. 20, 2014 (NL) 2013651

(51) Int. Cl. B62B 3/00; A47B 96/02; B62B 3/02; A47B 57/38

(52) U.S. Cl. CPC B62B 3/005; A47B 57/38; A47B 96/021; B62B 3/02

(57) ABSTRACT

A shelf for a rolling container, a rolling container provided therewith and a method for transporting and/or storing goods. The shelf according to the invention comprises: a loading surface suitable for placing goods thereon; two side edge profiles extending in longitudinal direction of the loading surface; two end profiles; and a number of connecting hooks arranged at or close to corner points of the loading surface arid configured for attachment to the rolling container, wherein the connecting hooks are provided with an integrally manufactured hook element and support surface, on which support surface, the loading surface is placeable.

### CROSS-REFERENCE TO RELATED APPLICATIONS

This application is a continuation application of Patent Cooperation Treaty Application No. PCT/NL2015/050668, filed on Sep. 25, 2015, which claims priority to Netherlands Patent Application Nos. 2013535 and 2013651, filed on Sep. 26, 2014 and Oct. 20, 2014, respectively, and the specifications and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

Field of the Invention (Technical Field)

The present invention relates to a shelf for a rolling container. Such rolling containers are used to transport goods, including supply or discharge of products within and between businesses.

Description of Related Art Including Information Disclosed Under 37 C.F.R. §§1.97 and 1.98

Diverse rolling containers for transporting goods are known in practice. These rolling containers make use of a carrier platform on which goods can be placed and wherein side walls, for instance in the form of a wire mesh, are placed at or on this carrier platform. Wheels are further provided in order to enable displacement of the rolling container. In order to arrange a plurality of loading levels therein, the rolling container is provided in practice with mesh profiles. Such mesh profiles are formed by girders over which a wire is fixed, for instance in loop form. This is relatively labor-intensive and not sufficiently stiff/strong for some applications. Also applied in practice are plastic shelves which are usually relatively costly to manufacture and likewise not always sufficiently stiff. Many shelves can in practice also not he attached easily or sufficiently firmly to the rolling container.

### BRIEF SUMMARY OF THE INVENTION

The present invention has for its object to obviate or at least reduce the above stated problems and to provide an effective and efficient shelf.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a view of a rolling container according to the invention provided with two types of shelf;

FIG. 2 shows a view of a connection of a first shelf to an upright;

FIG. 3 shows a view of a connection of a second shelf to an upright;

FIGS. 4-7 show views of the first shelf according to the invention; and

FIGS. 8-11 show views of the second shelf according to the invention.

### DETAILED DESCRIPTION OF THE INVENTION

The present invention provides for this purpose a shelf for a rolling container according to the invention, the shelf comprising:
a loading surface suitable for placing goods thereon;
two side edge profiles extending in longitudinal direction of the loading surface;
two end profiles; and
a number of connecting hooks arranged at or close to corner points of the loading surface and configured for attachment to the rolling container, wherein the connecting hooks are provided with an integrally manufactured hook element and support surface, on which support surface the loading surface is placeable.

By providing a loading surface suitable for placing goods thereon as well as side edge profiles and end profiles a stable shelf is obtained which is preferably manufactured from a galvanized metal. It is optionally possible as alternative to galvanized metal to work with other materials, including so-called wire decking, shelves provided in other materials and shelves of metal provided with a coating or covering layer. The metal used is preferably thin high-strength steel with a thickness of preferably less than 1 mm in order to thereby nevertheless obtain, with a light construction, sufficient stiffness and tensile strength for a shelf compared to conventional aluminium or plastic shelving.

In a currently preferred embodiment the loading surface is manufactured using roll forming. The design of the loading surface, and preferably at least a part of the profiles, is configured such that manufacture is possible in a roll forming process. In contrast to conventional shelves, this results in a cost-effective product.

According to the invention a shelf is provided at or close to corner points of the loading surface with arranged connecting hooks configured for attachment to the rolling container, in particular to the wire mesh or to an upright which is usually fixed directly or indirectly to the bottom surface of the rolling container. The connecting hooks are provided here with a hook element and a support surface which are manufactured integrally, on which support surface the loading surface is placeable. A loading surface can in this way be attached to the rolling container with the connecting hook as a single component. Compared to connecting hooks consisting of several components, the complexity of such a shelf is hereby reduced, as are the costs thereof.

In a possible embodiment according to the invention the connecting hook is connected fixedly to the shelf. In another currently preferred embodiment according to the invention the connecting hook is provided as separate component and in use is connected releasably to other parts of the shelf.

Owing to this configuration the connecting hook according to the invention also contributes toward strengthening of the corner of the shelf. Manufacturing the hook element and support surface integrally makes possible a strong connecting hook for the purpose of complementing the load-bearing capacity of the loading surface of the shelf according to the invention.

The connecting hook is preferably configured such that the hook element is attachable to different side walls or uprights of the rolling container. A flexibly attachable connecting hook is in this way provided so that the shelf can be attached in diverse ways to the rolling container. This enhances the utility of the shelf according to the invention. The connecting hook is preferably provided such that it is arrangeable on an upright in a direction substantially at right angles to the direction of movement of the rolling container. In an advantageous embodiment according to the invention the rolling container is provided for this purpose with a number of recesses configured to receive a part of the connecting hooks, wherein the recesses are provided substantially at right angles to the direction of movement of the rolling container. This is further elucidated in the present description relating to the rolling container according to the invention.

In the configuration of the connecting hook the hook element is preferably provided with a U-shaped profile, the legs of which are pinched together over at least a part of the height and over at least a part of the length of the U-shaped profile. A greater stiffness is imparted to the hook element by this pinching, pressing or folding together of a part of the legs. A greater stiffness and strength can hereby be realized while the weight remains the same or, conversely, a lighter weight of material can suffice while the strength and stiffness remain the same. An effective and also cost-effective connecting hook is in this way provided for the shelf according to the invention.

In a currently preferred embodiment the hook element is provided with a sound-damping material. Such a sound-damping material is preferably a rubber material. Sound caused by placing and removal of goods onto and from the shelf according to the invention and/or displacement of the rolling container is hereby reduced significantly. Working conditions for people involved in the displacement of goods is hereby greatly improved.

In an advantageous preferred embodiment according to the present invention the loading surface is configured such that liquid is drainable to the end profiles, and the end profiles are also provided with an outlet or outflow for discharge of the liquid.

By embodying the loading surface such that liquid can be discharged no liquid, including water, remains lying on the loading surface. This is better for the loading surface itself, and also better for the goods placeable thereon. The configuration of the loading surface can be provided for this purpose in slightly convex form and/or at an angle such that the liquid runs off to the end profiles. From the end profiles the liquid can be discharged in relatively simple manner from the outlet. The lifespan of the shelf according to the invention as well as the goods possibly placed thereon is in this way not jeopardized, and preferably even increased.

In an advantageous preferred embodiment according to the present invention the loading surface is provided with a number of grooves and/or openings. Among other effects, providing a number of grooves and/or openings reduces the weight of the shelf without causing a significant reduction in the strength and/or stiffness of the shelf. This further increases the user-friendliness of the shelf according to the invention. The grooves and/or openings can also have the additional function of draining liquid from the shelf.

In a further advantageous preferred embodiment according to the invention the loading surface is provided with integrally arranged side edge profiles. Providing integrally arranged side edge profiles enables manufacture of the side edge profiles and the loading surface from a single piece of sheet material. This configuration is preferably such that it can be produced via roll forming. The loading surface can be produced integrally with the side edge profiles in effective manner by employing a roll forming process. By subsequently making a shelf to size it is possible to then provide it with the end profiles. A shelf according to the invention can hereby be manufactured in effective manner.

In an alternative preferred embodiment according to the present invention the loading surface is provided with separately arranged side edge profiles. Separate arrangement of side edge profiles makes possible other configurations of the form of the side edge profile, which can be adapted to the specific application.

In an advantageous preferred embodiment according to the present invention a number of clinch connections are provided for connecting end profiles and/or side edge profiles to the loading surface. Through use of a clinch connections the profiles are connected fixedly to the loading surface of the shelf, wherein the for instance applied galvanized layer remains intact and pits or holes in which for instance water can accumulate are not created in the loading surface. If desired, it is possible to provide the clinch connection with an adhesive layer. Providing an adhesive layer, which is also understood to include a sealant layer, between the connecting surfaces achieves additional stiffness and strength. The sealing of the connection is also further improved and an additional protection is also realized against corrosion.

In a further advantageous preferred embodiment according to the present invention the shelf further comprises an RFID identifier. Providing an RFID identifier considerably increases the traceability of the shelf according to the invention. It is thus possible to track a shelf and/or monitor origin and destination. Additionally, or in combination with an RFID identifier or RFID tag, an identifier is preferably arranged during the process of manufacturing the shelf, such as a relief, or embossing, and/or a print. This increases the identifiability of the shelf and combats copying or confusion with other shelves. The traceability of the shelf is hereby also made possible and/or further increased. The identifiability of such shelves is hereby also increased. It has been found that applying such identifiers, preferably in combination with manufacture of the shelf using a roll forming process, provides a cost-effective and identifiable shelf.

Owing to the identifiability and traceability of the shelf according to the invention the shelves are highly suitable for use in a pool system. This considerably increases the utility of the shelves.

Provided in a currently preferred embodiment of the shelf according to the invention is a shelf with a four-point suspension which is manufactured from preferably one piece of sheet steel preferably having a thickness between 0.45 and 0.65 mm formed by means of roll forming and optionally folding. Particularly by providing a number of elements as described above, including one or more of providing a relief/embossing optionally running onto or over the edges of the shelf, a print on metal preferably wholly or partially in combination with an applied relief/embossing, a use of ink provided with so-called micro-tags, a tag such as an RFID tag, barcode and the like, an identifiable and traceable product is obtained which cannot be easily copied. The print is preferably arranged on the relief/embossing such that incidence of light generates an additional visual effect for further identifiability of the shelf according to the invention. The product hereby becomes extremely suitable for use in a pool system in which the use of shelves can be managed in effective manner.

The invention further relates to a rolling container provided with a shelf as described above. Such a rolling container provides the same advantages and effects as described for a shelf.

In a currently preferred embodiment according to the invention the rolling container comprises a number of uprights provided with a number of recesses configured to receive a part of the connecting hooks, wherein the recesses are provided substantially at right angles to the direction of movement of the rolling container. Providing the recesses in the uprights for the connecting hooks substantially at right angles to the usual direction of movement of the rolling container, therefore usually in width direction of the rolling container, achieves that during insertion of the shelves, in particular the connecting hooks thereof, the rolling container is not pushed away. Insertion of the shelves hereby becomes simpler. A further additional advantage is that insertion of the connecting hooks on a short side, i.e., the width direction of the rolling container, can be carried out in still more ergonomic manner. A further ergonomic advantage is that during placing of the shelf in the uppermost position, therefore in connection with the uppermost holes/recesses in the uprights for the connecting hooks, it is necessary to reach less high. This makes use of the shelf according to the invention more effective in practice.

The present invention further also relates to a method for providing an additional platform in a rolling container, comprising the step of placing a shelf in a rolling container as described above. Such a method provides the same effects and advantages as described for the shelf and/or the rolling container. It has been found that such a method provides one or more additional platforms or loading surfaces in a rolling container in effective manner so that a significant quantity of goods is placeable in simple manner in a rolling container. Providing connecting hooks comprising a hook element and a support surface which are manufactured integrally and on which support surface the loading surface is placeable makes it possible for a user of a rolling container to arrange a shelf at the desired position/height in effective manner in a rolling container. This significantly enhances the user-friendliness of the rolling containers provided with shelves according to the invention.

Particularly provided is a shelf with four-point suspension which is manufactured from preferably one piece of sheet steel preferably having a thickness between 0.45 and 0.65 mm formed particularly by means of roll forming and optionally folding.

A cost-effective product is obtained by manufacturing the loading surface of the shelf using roll forming. In a currently preferred embodiment side edge profiles or end edge profiles are manufactured simultaneously with the loading surface in the roll forming process. An identification is preferably also arranged in, on or at the shelf in the manufacturing process. Such an identification is for instance an RFID tag, a relief or embossing and/or a print. This increases the identifiability of the shelf and combats copying or confusion, resulting in a copy-proof product and other advantages.

The invention further also relates to a method for managing shelves for a rolling container as described above. Such a method provides the same effects and advantages as described for the shelf and/or the rolling container. Particularly by providing a number of elements as described above, including one or more of providing a relief/embossing optionally running onto or over the edges of the shelf, a print on metal preferably wholly or partially in combination with an applied relief/embossing, a use of ink provided with so-called micro-tags, a tag such as an RFID tag, barcode and the like, an identifiable and traceable product is obtained which cannot be easily copied. The print is preferably arranged on the relief/embossing such that incidence of light generates an additional visual effect for further identifiability of the shelf according to the invention. The product hereby becomes extremely suitable for use in a pool system in which the use of shelves can be managed in effective manner.

The invention further also relates to a connecting hook configured to support a shelf as described above and comprising an integrally manufactured hook element and support surface, on which support surface the loading surface is placeable. Such a connecting hook provides the same effects and advantages as described above for a shelf, rolling container and/or method. The connecting hook consists particularly of a single element consisting of the hook element and the support surface. A connection is hereby realized in effective manner between the loading surface and a rolling container.

Further advantages, features and details of the invention are elucidated on the basis of preferred embodiments, wherein reference is made to the accompanying drawings.

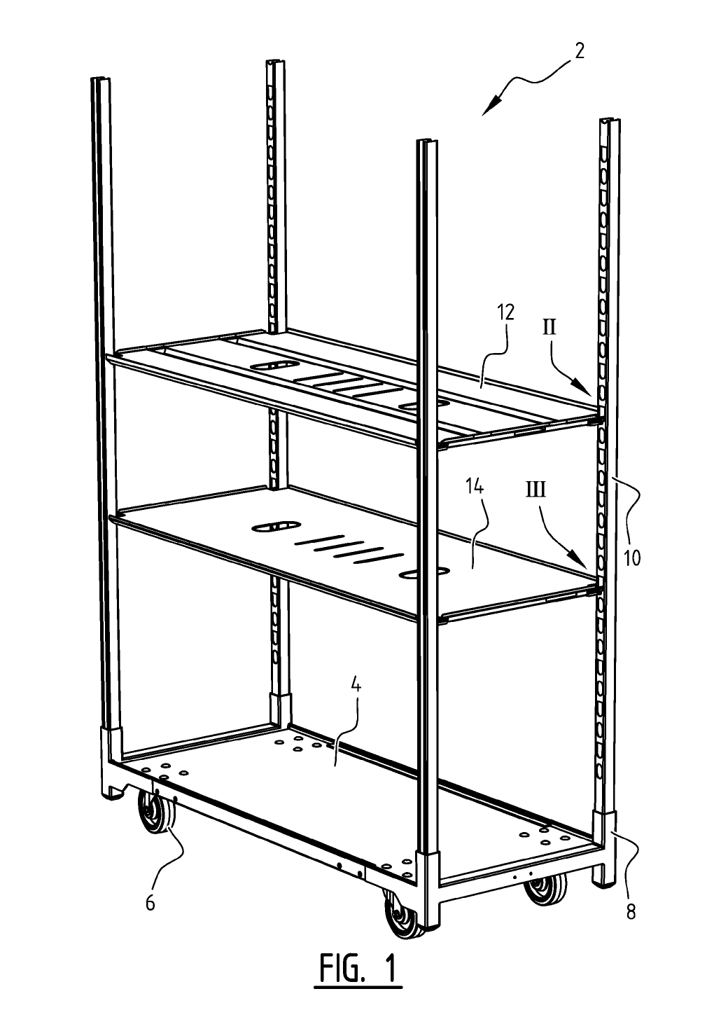

Rolling container 2 (FIG. 1) comprises a support frame or bottom sheet 4 on which a number of wheels 6 are arranged. Also arranged on bottom sheet 4 are connecting elements in the form of profiles 8 in which uprights 10 are arrangeable. In the shown embodiment bottom sheet 4 serves as first loading surface. For additional loading surfaces the shown rolling container 2 is provided with shelf 12 of a first type and with a shelf 14 of a second type. It will be apparent that shelves 12, 14 of a single type will usually be applied in practice in one rolling container 2.

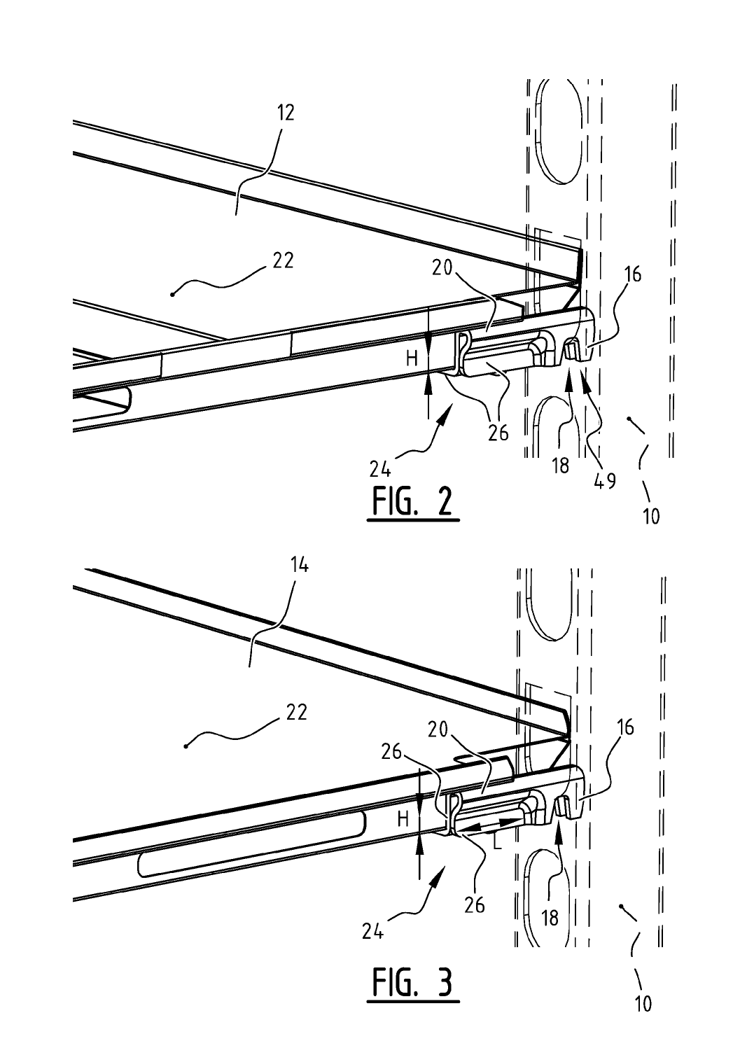

Shelves 12, 14 (FIGS. 2-3) are attached using connecting hooks 16 to uprights 8. In the shown embodiment connecting hook 16 is the same for both types of shelf 12, 14. Connecting hook 16 consists of hook element 18 and support surface 20. Hook element 16 is attachable to upright 10. Loading surface 22 of the shelf is placeable on support surface 20. Hook element 16 comprises a U-shaped profile 24 with two legs. Legs 26 are pressed together along a height H and along a length L.

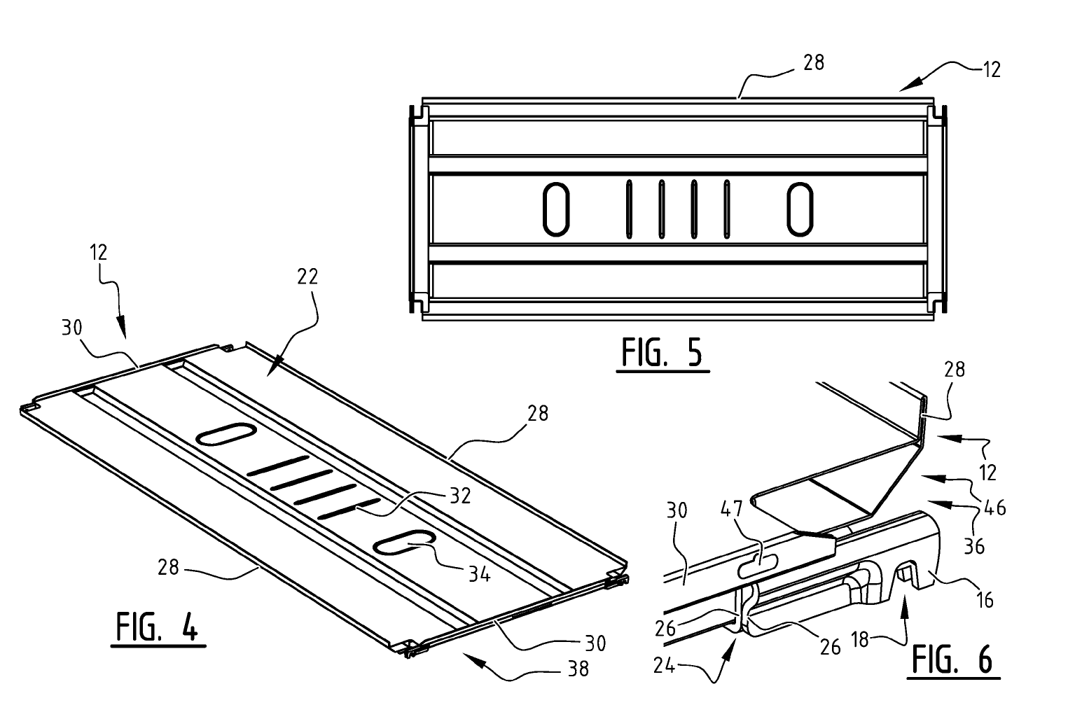

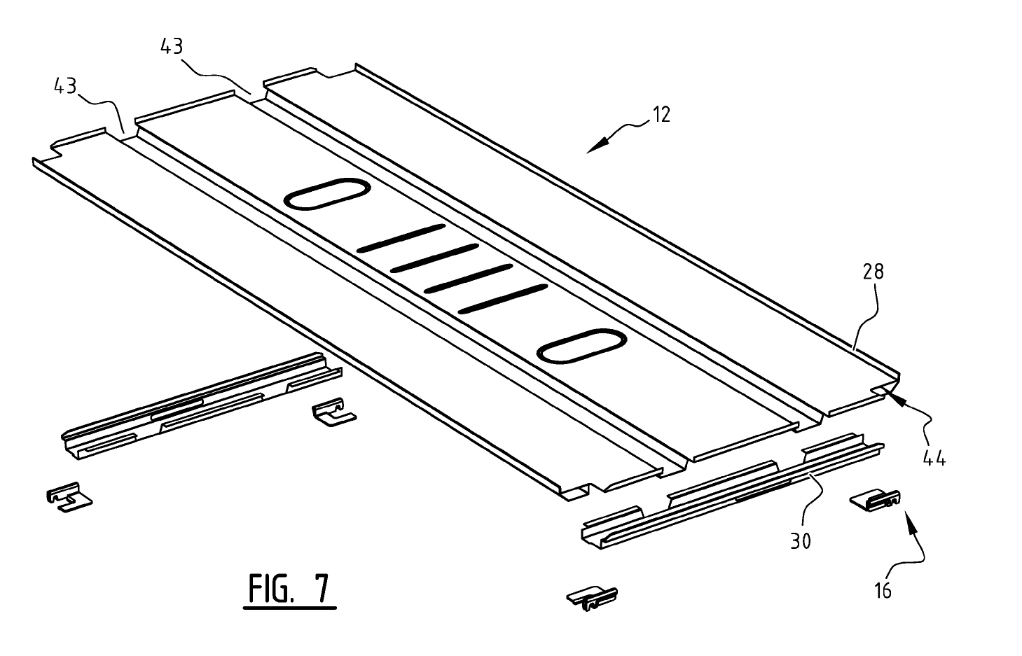

Shelf 12 (FIGS. 4-7) is provided with two side edge profiles 28 and two end profiles 30. In the shown embodiment the loading surface is provided with a number of grooves 32 and openings 34 for the purpose, among others, of draining liquid from loading surface 22. Liquid can be drained from loading surface 22 to end profiles 30. The end profiles are provided with outflow 36 for discharging the liquid.

Shelf 12 is further provided with side edge profiles 28 which extend in longitudinal direction of shelf 12. Clinch connection 38 connects end profiles 30 to loading surface 22.

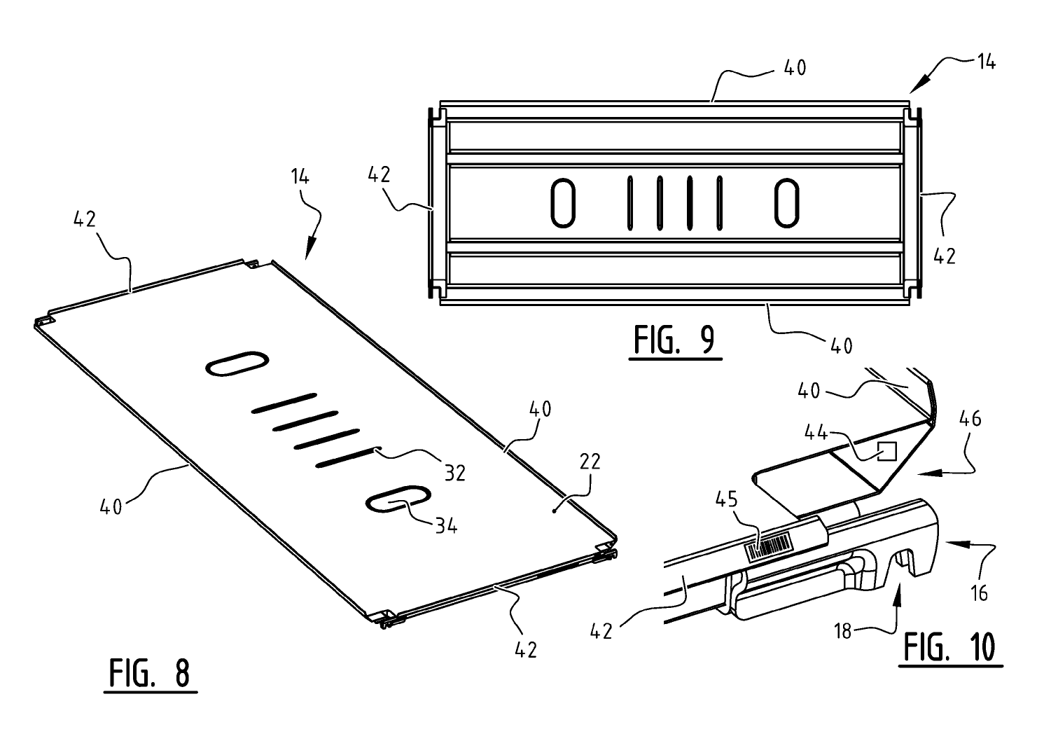

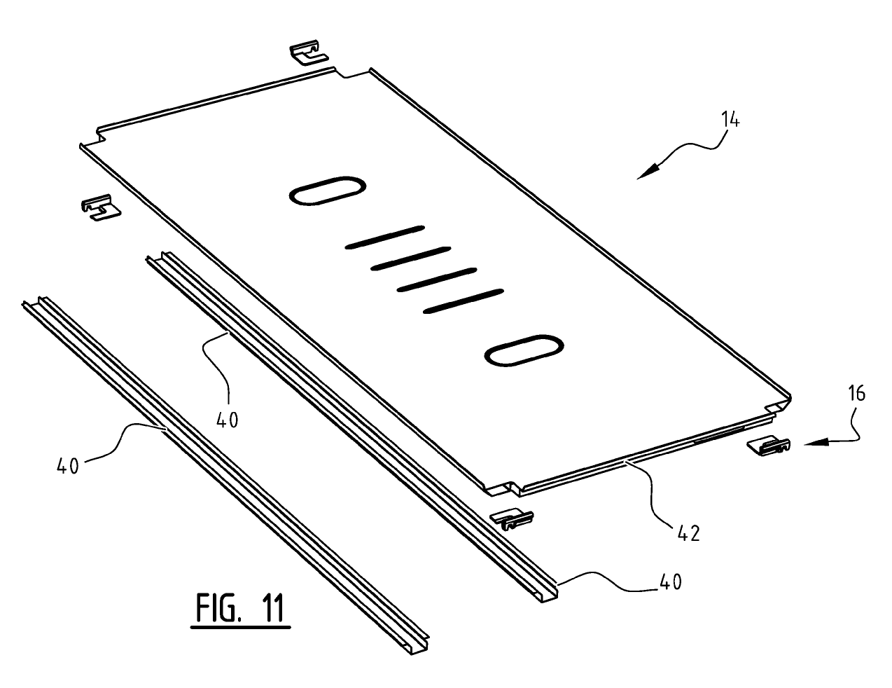

In another embodiment shelf 14 (FIGS. 8-11) with a number of clinch connections 38 is provided with separate side edge profiles 40 attached to loading surface 22 as alternative to roll forming of loading surface 22 with integrated side edge profile 28 from one sheet of material. In the shown embodiment shelf 14 is provided with integrally arranged end profiles 42. It will be apparent that it is also possible according to the invention to provide separate side edge profiles 40 and separate end profiles 30 and to attach these, for instance with clinch connections 38, to loading surface 22.

Shelves 12, 14 are optionally provided with longitudinal grooves 43 which are preferably realized by roll forming. In the shown embodiment connection 38 is also provided with an adhesive layer for better fixing and sealing. An RFID chip 44, barcode 45, print 47 and/or other identifier is also provided.

Shelf 12, 14 is manufactured from sheet material, in particular from a galvanized metal.

The connecting hook is provided with rubber part 49 for the purpose of providing a sound damping.

In a first embodiment shelf 12 (FIGS. 4-7) is provided with an integrated loading surface 22 with side edge profiles 28, formed for instance by roll forming. It will otherwise be apparent that, depending to some extent on the desired configuration, it is possible for a loading surface 22 with side edge profile 28 to be obtained by folding. End edge profiles 30 are preferably secured with clinch connection 38 to integrated loading surface 22 with side edge profile 28. Provided close to the corner points of shelf 22 is recess 46 in which upright 10 can be received. A second type of shelf (FIGS. 8-11) is optionally also (partly) manufactured by roll forming, although other production methods such as folding are also possible.

It is possible if desired to additionally apply a relief or embossing to shelf 12, 14 for the purpose of further identification by a user and/or owner. An additional recess or fold can also be added to for instance end profile 30, 42 in order to increase ease of handling of shelves 12, 14 for the user.

Optional strengthening ribs are provided on the underside of shelf 12, 14. The number and form of the strengthening ribs can be adapted to the anticipated load on shelf 12, 14.

For the purpose of transporting goods rolling container 2 is in a position of use in which bottom surface 4 functions as first loading surface and a number of additional shelves 12, 14 are arranged on rolling container 2. Goods are subsequently placed on loading surface 20 and if desired transported, after which goods are once again removed. When rolling container 2 is not in use, rolling container 2 can be stored with shelves 12, 14 in position. It is however usually preferred to remove shelves 12, 14 from rolling container 2 after use and to store and/or transport them separately.

The present invention is by no means limited to the above described preferred embodiments thereof. The rights sought are defined by the following claims, within the scope of which many modifications can be envisaged.

What is claimed is:

1. A shelf for a rolling container, comprising:
a loading surface suitable for placing goods thereon;
two side edge profiles extending in longitudinal direction of the loading surface;
two end profiles; and
a number of connecting hooks arranged at or close to corner points of the loading surface and configured for attachment to the rolling container, wherein the connecting hooks are provided with an integrally manufactured hook element and support surface, on which support surface the loading surface is placeable.

2. The shelf as claimed in claim 1, wherein the connecting hooks are connected releasably to other parts of the shelf.

3. The shelf as claimed in claim 1, wherein the connecting hook is configured such that the hook element is attachable to different side walls of the rolling container.

4. The shelf as claimed in claim 1, wherein the hook element comprises a V-shaped profile, the legs of which are pinched together over at least a part of the height and over at least a part of the length of the V-shaped profile.

5. The shelf as claimed in claim 1, wherein the hook element is provided with a sound-damping material.

6. The shelf as claimed in claim 1, wherein the loading surface is configured such that liquid is drainable to the end profiles, and the end profiles are provided with an outlet or outflow.

7. The shelf as claimed in claim 1, wherein the loading surface is provided with a number of grooves and/or openings.

8. The shelf as claimed in claim 1, wherein the loading surface is provided with integrally arranged side edge profiles.

9. The shelf as claimed in claim 1, wherein the loading surface is provided with separately arranged side edge profiles.

10. The shelf as claimed in claim 1, wherein a clinch connection is provided for connecting the end profiles and/or side edge profiles to the loading surface.

11. The shelf as claimed in claim 10, wherein the clinch connection is provided with an adhesive layer.

12. The shelf as claimed in claim 1, further comprising an RFID identifier.

13. The shelf as claimed in claim 1, further comprising a relief and/or a print.

14. The shelf as claimed in claim 1, wherein the shelf is manufactured substantially from galvanized metal.

15. A rolling container provided with a shelf as claimed in claim 1.

16. The rolling container as claimed in claim 15, further comprising a number of uprights provided with a number of recesses configured to receive a part of the connecting hooks, wherein the recesses are provided substantially at right angles to the direction of movement of the rolling container.

17. A method for providing an additional platform in a rolling container, comprising placing a shelf in a rolling container as claimed in claim 15.

18. The method as claimed in claim 17, further comprising roll forming of the loading surface.

19. A method for managing shelves for a rolling container as claimed in claim 15.

20. A connecting hook configured to support a shelf as claimed in claim 1, comprising an integrally manufactured hook element and support surface, on which support surface the loading surface is placeable.
